(19) United States
(12) Patent Application Publication
(10) Pub. No.: US 2016/0184748 A1
(43) Pub. Date: Jun. 30, 2016

(54) Floating Filtration Apparatus Transfers Seawater without Harm to Marine Life,

(71) Applicants: Thomas Scott Manaugh, Dallas, TX (US); Said Omar Majdi, Dallas, TX (US)

(72) Inventors: Thomas Scott Manaugh, Dallas, TX (US); Said Omar Majdi, Dallas, TX (US)

(21) Appl. No.: 14/979,427

(22) Filed: Dec. 27, 2015

Related U.S. Application Data
(60) Provisional application No. 62/124,692, filed on Dec. 30, 2014.

(51) Int. Cl. B01D 35/05; C02F 1/00

(52) U.S. Cl. CPC B01D 35/05; C02F 1/004; C02F 2103/08

(57) ABSTRACT

A floating filtration apparatus prevents harm to marine life when seawater is withdrawn from an ocean. The apparatus has a floating framework that largely surrounds a space into which water rises from below to find its own level. The water passes through a porous filter as it moves upward into the space, thus producing filtered water that has had marine life gently screened out. A continuous flow of filtered water is achieved when the filtered water in the space is pumped away and new, unfiltered water from below passes upward through the filter and into the space. Water pumped away from the apparatus does not contain marine life that could be killed in the pipes and pumps that bring seawater to cool a power plant or supply a desalination facility.

### CROSS-REFERENCE TO A RELATED APPLICATION

This utility application claims the benefit of U.S. Provisional Patent Application Ser. No. 62/124692 filed Dec. 30, 2014, by Thomas Manaugh and Saïd Majdi, which is hereby incorporated by reference.

### STATEMENT REGARDING FEDERALLY SPONSORED RESEARCH OR DEVELOPMENT

No federally sponsored research or development was used in the creation of this invention.

### BACKGROUND OF THE INVENTION

Seawater can be withdrawn from an ocean to be used for cooling power plants, producing desalinated water, and other purposes. Marine life (e.g., small fish, larvae, and eggs) can be killed if they are scooped into the seawater that goes from the ocean and into a plant. Environmentally responsible protection of marine life from being harmed requires a means of filtration so marine life will not be harmed by being entrapped and entrained in a system of pipes and pumps that conveys seawater away from an ocean.

The “gold standard” for environmentally responsible filtration is to filter seawater through a layer of sand at the bottom of the ocean before it is pumped through a gallery of collection pipes that are buried below the sand. Protection of marine life occurs because marine life will not pass readily through a layer of sand that is even a few inches deep.

However, construction of such a filtration gallery is very expensive and not all locations are suitable for installation of a sand-covered gallery of collection pipes. These two factors serve to make desirable a less expensive means of filtering seawater to protect marine life and, especially, to be able to protect marine life even in locations where geographical features do not readily accommodate construction of a sand-covered gallery of collection pipes.

Other criteria for identifying an improved means of filtration of seawater intake include (a) scalability to provide a required quantity of water per unit of time, (b) reliability of operation, (c) ease of inspection and maintenance, and (d) simplicity of construction.

### BRIEF SUMMARY OF THE INVENTION

When water is taken from a body of water, it is likely that marine life will inadvertently be scooped up along with the water and that it could be harmed. Needed is a practical and effective way to remove water while gently screening out marine life. The most effective screening method now known—collecting water from a gallery of sand-covered collection pipes underneath the floor of an ocean—is very expensive and cannot be constructed in many locations.

Disclosed here is a floating filtering apparatus that will effectively and inexpensively screen out marine life at a fraction of the cost the gallery described above. The filtering apparatus comprises a floating framework that surrounds an “evacuation” space into which water will flow slowly upward to its own level, passing through a filter through which marine life will not pass. The filter can be comprised of pebbles that are constrained in their movement by a mesh above and below.

Water that passes upward through the filter can be pumped away, allowing new water to pass upward through the filter and into the evacuation space. A continuous flow of filtered water can be achieved when filtered water is continuously removed from the evacuation space. When filtered water is pumped away from the apparatus, it does not contain marine life that could be killed in the pipes and pumps that bring seawater to cool a power plant or supply a desalination facility.

The flow of unfiltered water up into the filter is slow enough (less than 0.5 feet per second) that marine life does not become entrained or entrapped. Miscellaneous particulates could enter the crevices of the filter and cause some clogging, but they would tend to become dislodged and drift away during times when water was not being pumped from the evacuation space.

Active cleaning of the filter can be accomplished by (a) shaking, backwashing, or vacuuming the filter or (b) routine maintenance where filtering materials are removed and cleaned or replaced, as needed.

### BRIEF DESCRIPTIONS OF THE DRAWINGS

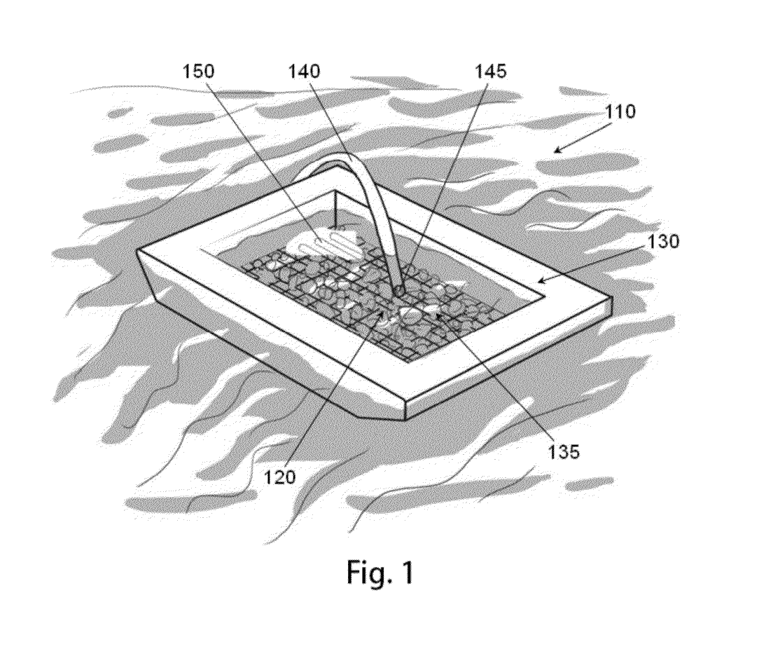

In FIG. 1 an embodiment of the invention is shown in a front perspective view from above. The embodiment is called a “Leaky Barge”for purposes of exposition.

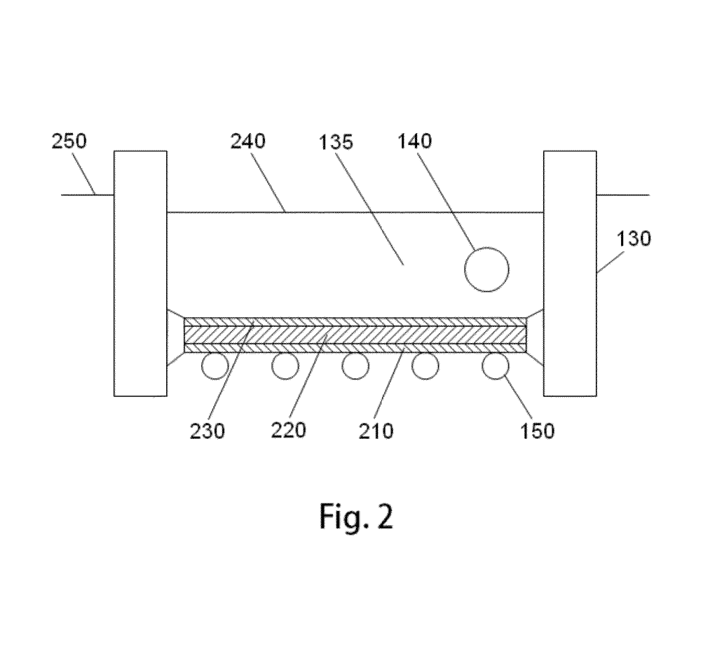

In FIG. 2 the same embodiment of the invention is again seen from the front, but in a cross-sectional view.

### DETAILED DESCRIPTION OF THE INVENTION

It is expeditious to describe the invention by introducing the simple embodiment of a “leaky barge” that floats in water 110, as shown in FIG. 1. Said barge has a buoyant framework 130 and a central space 135 surrounded by the framework. Water easily flows upward into the central space when the barge floats partially immersed in water. Entering water passes upward through a porous, rectangular, flat filter 120 that completely stretches across the area defined by the sides of the framework near the bottoms of the sides. Water rises to a level inside the barge that is as high as the water outside the barge except the level inside the barge will stay somewhat lower when water is being removed by pumping.

When water is pumped away from the central space 135 of the barge through a hose 140 with an opening in the end of the hose 145 that is underwater, water will continue to pass upward through the filter as long as pumping continues.

The filter is supported from below by a series of rigid supporting rods 150 that attach to opposite sides of the framework 130. Where the illustration of the filter is cut away in FIG. 1, one can see parts of the supporting rods that are placed under the filter to keep it from sagging or breaking away from the framework.

In FIG. 1 the hose is shown to trail away into the central space 135 above the water and over a side of the framework. Not shown is a second end of the hose that is attached to a pump (also not shown) that is used to draw away water that has penetrated upward through the filter.

If the filter is impenetrable to marine life, the filter will protect marine life from entering the central space and being pumped away. The velocity of the water passing upward through the filter should be slow enough that marine life would not be swept upward and trapped against the lower surface of the filter. An upward velocity of up to 0.5 feet per second is consistent with protection of marine life.

In FIG. 2 is shown from the front the same framework of the leaky barge that is shown in FIG. 1. However, the view is cross-sectional. Supporting rods 150 and lateral sides of the framework 130 can be seen in cross-section. It can be seen that the filter is composed of a bottom mesh 210 that is tight enough and strong enough to contain filtering material of pebbles 220 and a top mesh 230 that serves to stop the pebbles from shifting around. Ties between the top and bottom mesh (not shown) also serve to limit movement of the pebbles. Filtering materials other than pebbles (for example, organic fibers and sand) could be used.

The level of water inside the barge 240 is slightly lower than the level of water outside the barge 250 because water is being pumped away through a hose 140.

Setting aside the example of the leaky barge, a more general description of the invention is of a filtration apparatus that includes a buoyant, water-impenetrable framework. The framework is made of a rigid material, but is largely hollow or made of very light-weight material. Displacement of water by the framework is such that the framework stays afloat even with any burdens or attachments to the framework that are parts of the entire filtration apparatus or that serve in its operation.

A central space is largely surrounded by the framework but is open at the bottom to a body of water in which the framework floats. The framework floats only partially submerged in the body of water. Water rises in the space inside the framework to the level of the water in which the framework floats.

Water that rises within the space is surrounded on four sides by the framework and by a porous, flat filter at the bottom of the space. Thus, all the water that occupies the space surrounded by the framework and above the filter is filtered water. When that water is drawn away, new water flows upward into the space through the filter. That new water is filtered water. For purposes of exposition, the central space holding the filtered water is called the “evacuation space.” All the water that is drawn away from the evacuation space by pumping or other means is filtered water that can be used for cooling, desalination, or any other purpose.

The filtering process can continue more or less continuously. Some interruption may be required for occasional cleaning, replacement of filtering materials, or repairs.

When water is pumped or siphoned from the evacuation space, it can be directed by valves to (a) a location to accept or store filtered water, (b) back into the body of water on which the filtration apparatus floats, or (c) to a disposal site during a cleaning cycle.

When water is pumped from the evacuation space, replacement water easily enters upward from underneath the filtration apparatus to replace water that has been pumped out. Because the area of entry through the filter can be large, a current of water flowing upward can be very slow—even much slower than the 0.5 feet per second intake velocity that is considered safe for marine life. A large area of entry accommodates flow of a large volume of water per unit of time even when the flow into the evacuation space is slow.

The water entering slowly upward from below passes easily through a mesh that allows passage of water and also supports a single layer or multiple layers of porous filtering materials that lie on top of the mesh. The filtering material could be pebbles or any other material that easily allows passage of water but would serve as a barrier to even a very small fish swimming upward through the bottom mesh and toward the evacuation space where water is removed. The fish would encounter what to a human would be comparable to an avalanche of boulders completely clogging a roadway.

Non-swimming marine life could not be swept upward into the filtration apparatus because the current of water entering the evacuation space would be much too slow for sweeping upward any non-floating materials. Fish eggs, for example, are heavier than water and tend to sink. They would not float or be swept upward into the evacuation space.

The above description of a filtration apparatus invention shows how a continual process of water filtration can be accomplished by using the principle that water will find its own level. Thus, water flowing to find its own level passes upward through filtering materials and is pumped away from the space above the filtering level. Pumping facilitates a constant upward flow of filtered water.

Eventually, the filtering materials will become partially clogged with particles that the filtering materials have trapped. When the pumping process is halted, those particles will tend to become dislodged from the filtering materials. The natural movement of water in a body of water will cause the trapped particles to drift away from where they were trapped in the filtering materials. They will tend to drift downward and away from the filtration apparatus. Thus, a natural “back wash” process will start to occur when pumping is halted, That natural process can easily be augmented by (a) shaking, backwashing, or vacuuming the filter or (b) routine maintenance where filtering materials are removed and cleaned or replaced, as needed.

While the present invention is described herein with a reference to an illustrative embodiment for a particular application, it should be understood that the invention is not limited thereto. Those having ordinary skill in the art and access to the teachings provided herein will recognize additional modifications, applications, and embodiments within the scope thereof and additional fields in which the present invention would be of significant utility. An embodiment, for example, might include filtration of a liquid other than water and a filtration medium other than pebbles. The shape of the framework could be other than rectangular.

It is therefore intended by the appended claims to cover any and all such applications, modifications and embodiments within the scope of the present invention.

What is claimed is:

1. A filtering apparatus floating in a body of liquid that prevents solid objects from being entrained or entrapped in a flow of liquid that is conveyed from the body of liquid, the filtering apparatus comprising a floating framework that is partly immersed and that largely surrounds a space inside the framework into which the liquid flows upward to the level of the body of liquid, passing through a porous filter that is near the bottom of the apparatus and that blocks passage of solid objects.

2. The filtering apparatus according to claim 1 wherein the body of liquid is a body of water.

3. The filtering apparatus according to claim 1 wherein the solid objects to be filtered are marine life.

4. The filtering apparatus according to claim 1 where the liquid in the space above the filter is removed so that liquid continues to flow upward into the space, thereby producing a continuous flow of liquid upward into the space and a constant production of filtered liquid so long as the removal of liquid from the space continues.

5. The filtering apparatus according to claim 1 where the filter is supported from below by a series of rods that attach to the framework.

6. The filtering apparatus according to claim 1 wherein the porous filter comprises a layer of pebbles that serve as a barrier to upward penetration by solid objects.

7. The filtering apparatus according to claim 1 wherein the filter is constrained in place by a mesh layer above the filter and a mesh layer below the filter.

8. The filter according to claim 7 wherein the filter comprises pebbles that are constrained in place by the mesh layer above the filter and the mesh layer below the filter.
